(19) United States
(12) Patent Application Publication
(10) Pub. No.: US 2010/0122560 A1
(43) Pub. Date: May 20, 2010

(54) Theft Deterrent Device and Method for Bags

(76) Inventors: Victoria Marie Ricker, Plainfield, IL (US); Martha Helen Curnow, Schaumburg, IL (US)

Correspondence Address: BISHOP & DIEHL, LTD., 1320 TOWER ROAD, SCHAUMBURG, IL, 60173, US

(21) Appl. No.: 12/690,457

(22) Filed: Jan. 20, 2010

Related U.S. Application Data
(63) Continuation-in-part of application No. 11/895,825, filed on Aug. 28, 2007.
(60) Provisional application No. 60/840,963, filed on Aug. 30, 2006.
(60) Provisional application No. 60/907,931, filed on Apr. 23, 2007.

(51) Int. Cl. E05B 65/52; A45C 13/18

(52) U.S. Cl. 70/66; 70/64; 190/101; 150/102

(57) ABSTRACT

A theft deterrent device for use with a bag, such as a purse, backpack or computer bag, and a method of deterring theft of an unsupervised bag. The device includes a housing with a connector attached to the housing, and a locking member with a retractable cord attached to an opposing side of the housing for use in securing the bag to a stationary object. Alternatively, the device includes a connector, attachment means and at least one locking member. The device may further include a second locking member attached to the connector through a second attachment means useful for securing a zipper on a bag to prevent easy access to the contents of the bag.

### CROSS-REFERENCE TO RELATED APPLICATIONS

This application is a continuation-in-part of application Ser. No. 11/895,825, filed on Aug. 28, 2007, which claims priority to U.S. Provisional Patent Application Ser. No. 60/840,963, filed Aug. 30, 2006 and U.S. Provisional Patent Application Ser. No. 60/907,931, filed Apr. 23, 2007. These applications are incorporated by reference herein.

### FEDERALLY SPONSORED RESEARCH OR DEVELOPMENT

Not Applicable.

### TECHNICAL FIELD

The present application relates to a theft deterrent device and method, and specifically to a device useful for releasably securing bag items, such as purses, backpacks, diaper bags and computer bags to stationary objects to discourage theft. The invention further includes a method for deterring theft through the use of a theft deterrent device of the present invention on a bag. The present invention further includes a zipper securing device, which can be used separately or incorporated into the theft deterrent device.

### BACKGROUND OF THE INVENTION

Theft of purses and other personal bag items, such as backpacks, briefcases and computer bags is a common problem. Often, the owner of the bag will place the bag on the back of a chair, in a stroller or a grocery cart, inviting easy theft of the entire bag or pick pocketing of wallets, electronic devices or other important items out of the bag. Pick pocketing is often accomplished while the purse or bag is being carried on the person's body as well.

Given the fashionable aspect of most bags, using a pad lock with a cable or combination lock may serve the purpose of locking the bag; however it is not necessarily an attractive or convenient option. Locks and cables would need to be portable and stored when not in use, which may not be convenient for the user. The present invention is designed to provide a user-friendly, portable means for securing a bag to a stationary object, or large movable object, such as a grocery cart, while disguised as a decorative accessory maintaining the fashionable nature of the bag. The present invention further includes a means for securing the zipper on a bag in a closed or partially closed position, to deter theft of articles inside the bag.

### SUMMARY OF THE INVENTION

The present invention generally relates to a theft deterrent device for a bag, such as a purse. In one embodiment, the theft deterrent device comprises a housing, a connector attached to one side of the housing, at least one locking member attached to an opposing side of the housing, a cord having first and second ends, the first end of the cord coupled to the locking member, and the second end of the cord being coupled to a retracting member disposed within the housing for retracting and releasing the cord and the locking member.

According to another embodiment of the invention, the theft deterrent device comprises a housing, a connector attached to one side of the housing, a first locking member attached to an opposing side of the housing, a cord having a first end coupled to a first locking member and a second end coupled to a retracting member, the retracting member disposed within the housing for retracting and releasing the cord and the first locking member, and a second locking member connected to the connector through a second attachment means.

According to another embodiment of the present invention, the theft deterrent device comprises a connector, an attachment means, and at least one locking member.

According to yet another embodiment of the present invention, a method for deterring theft of an unsupervised bag is described. The method comprises the steps of providing a device comprising a connector, an attachment means attached to the connector and at least one locking member positioned on the attachment means. The method includes the steps of attaching the connector to a bag, wrapping the attachment means around an object to which the bag is to be secured, and connecting the locking member to the connector. This embodiment may also include a second locking member connected to a second attachment means attached to the connector. The second locking member may be used to secure the zipper in a closed position on the bag.

According to yet another embodiment of the present invention, a method for deterring theft of an unsupervised bag, is described. The method comprises the steps of providing a device comprising an attachment means having a first end and a second end, a first locking member attached to the first end of the attachment means and a second locking member attached to the attachment means in close proximity to the first locking member. The method further includes the steps of wrapping the attachment means about an object to which the bag is to be secured, connecting the first locking member to the second end of the attachment means, connecting the second locking member to a closure device on the bag.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is perspective view of the theft deterrent device of the present invention.

FIG. 2 is a detailed perspective view of the theft deterrent device of the present invention.

FIG. 3 is a detailed perspective view of one embodiment of the theft deterrent device of the present invention.

FIG. 4 is a front view of the housing of the theft deterrent device of the present invention.

FIG. 5 is a cross sectional view taken along lines 5-5 of the housing of FIG. 6.

FIG. 6 is a perspective view of another embodiment of the theft deterrent device of the present invention.

FIG. 7 is a perspective view of another embodiment of the theft deterrent device of the present invention.

FIG. 8 is a perspective view of another embodiment of the theft deterrent device of the present invention.

FIG. 9 is a perspective view of yet another embodiment of the theft deterrent device of the present invention.

### DETAILED DESCRIPTION

While this invention is susceptible of embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated.

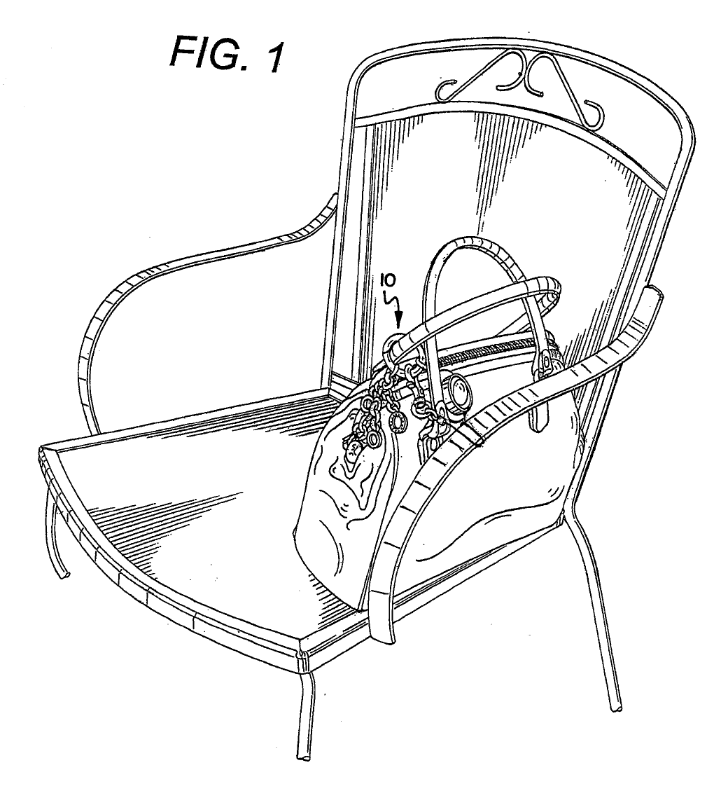

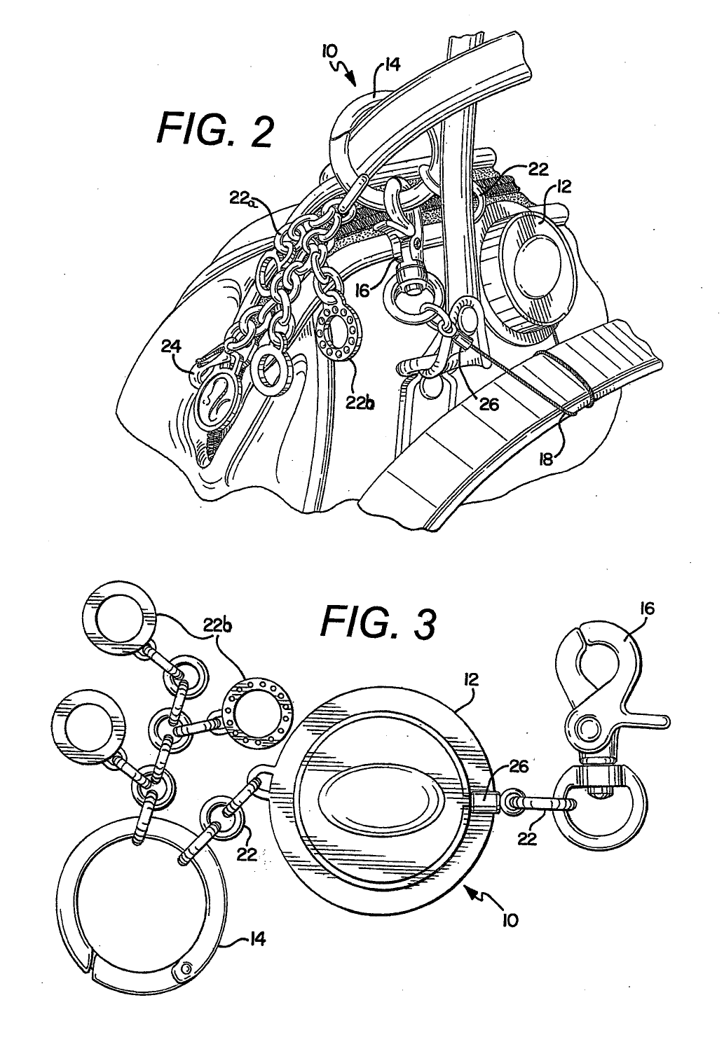

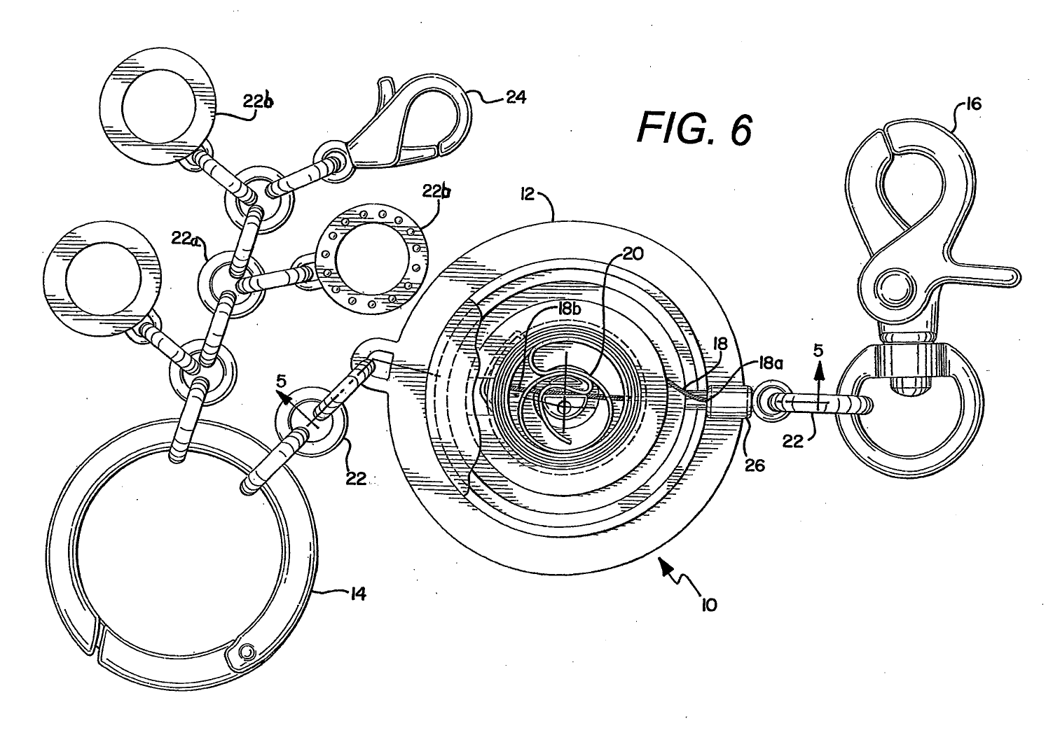

Turning now to the Figures, FIG. 1 is a perspective view of the first embodiment of the present invention, showing the invention in use as a theft deterrent device 10, for securing a bag or purse to a generally stationery object, such as a chair, or to a large movable object, such as a grocery cart. In general, and as shown in FIG. 2, the device 10 comprises a housing 12, a connector 14 attached to one side of the housing through attachment means 22, at least one locking member 16 attached to an opposing side of the housing through attachment means, a cord 18 having first 18a and second end 18b, the first end coupled to the locking member through a casing 26 and attachment means, and the second end coupled proximate to a retracting member 20, shown in FIGS. 5 and 6, disposed within the housing for retracting and releasing the cord and the locking member. The device 10 and its component parts can be constructed of any durable material, such as plastic or metal.

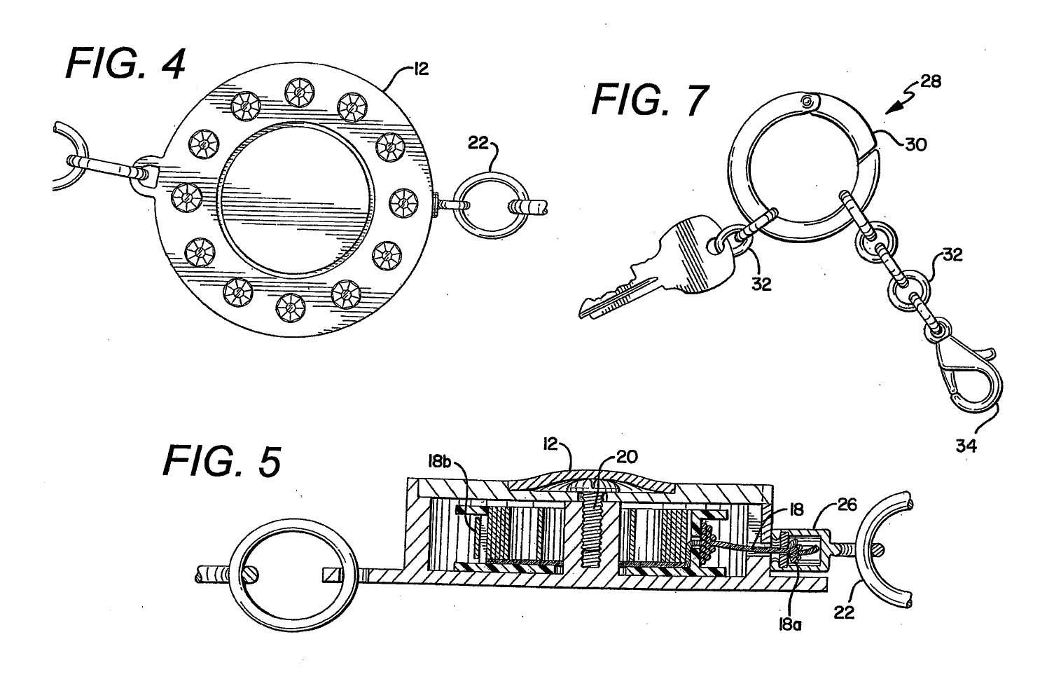

As shown in FIGS. 3 and 4, the device 10 comprises a housing 12. The housing 12 includes a connector 14 attached to one side of the housing by attachment means 22, and a locking member 16 attached to an opposing side of the housing. The housing 12 can have any geometric shape, including but not limited to, square, oval, or circular. Preferably, the housing 12 is circular and can be constructed of any suitable durable material, such as plastic or metal. As shown in FIG. 4, the housing 12, including the outer cover of the housing, can include a decorative element, such as crystals, real or faux gems, engraved wording, silk flowers, or any other suitable embellishment.

As shown in FIG. 6, a retracting member 20 is located within the interior of the housing 12. The retracting member 20 includes a spring loaded mechanism, as is generally known in the art.

As shown in FIG. 3, one end of the housing 12 includes a connector 14. The connector 14 can be attached to the housing 12 by any suitable attachment means 22, including a chain, wire, cord or cable. Preferably, the attachment means is at least one metal chain link or ring, which permits movement between the connector 14 and the housing 12. The connector 14 can be any suitable geometric shape, preferably circular. The connector 14 should be easy to attach to and remove from the strap of a bag, and therefore a biased closure member, movable between open and closed positions, is preferred. Preferably, the connector 14 is a hinged ring, which opens with slight inward pressure and biases toward a closed position to seal the opening. The connector 14, however, could be of any form suitable for securing and removing the device 10 to the bag, and thus could include a clip, clasp or any other suitable means for removing and attaching the device to the bag.

As further shown in FIG. 3, also attached to the housing 12 is at least one locking member 16. The locking member 16 is secured to the housing 12 through an attachment means 22, including a link or ring, a casing 26 and a cord 18 secured within the housing, as shown in FIG. 5. The locking member 16 can be any form of securing member such as a toggle, hook, or snap clasp. Preferably, the locking member 16 is a spring-loaded fastener, such as a lobster claw or snap clasp. As with the housing 12, the locking member 16 can be constructed from any durable material, such as plastic or metal. Preferably, the locking member 16 is constructed from a lightweight metal for security, longevity after repeated use, as well as decorative appeal. When in use, the locking member 16 attaches to the connector 14 securing the bag to the stationary object.

Referring to FIGS. 2 and 5, on the attachment means 22 opposite to the locking member 16, is connected a retractable cord 18 having first end 18a and a second end 18b. The first end 18a of the cord 18 is attached by a secure method such as a knot or gluing, within a casing 26 which is secured to the attachment means 22 and then to the locking member 16. When not in use, the cord 18 is retracted and stored within the housing 12, with the second end 18b of the cord wrapped around a spool portion of a retracting member 20, and further secured within the retracting member by knotting or gluing. The retracting member 20 can be a standard spring loaded mechanism known in the art, such as a flat coil spring surrounded by a plastic spool. The retracting member 20 permits easy release of the cord 18 from the housing 12 using the locking member 16. The cord 18 is then wrapped around the portion of the stationary object, such as the arm of a chair, and the locking member 16 is secured to the connector 14, securing the bag to the stationary object. When the locking member 16 is released from the connector 14, the retracting member 20 automatically winds the cord 18 back into the housing 12. The cord 18, which can be any length suitable for the present invention, can be made from any durable, strong, flexible material so that it is not easily broken, such as stainless steel, nylon, flexible wire or plastic. Preferably, the cord 18 is nylon or plastic coated stainless steel.

FIG. 6 shows a second embodiment of the present invention. This embodiment includes a second locking member 24. The second locking member 24 is attached to the connector 14 through a suitable attachment means 22a, which is separately connected to the connector from the first attachment means 22 and first locking member 16. The second attachment means 22a may be constructed from a chain, wire, cord or cable, similar to first attachment means 22 used in connection with the first locking member 16. Preferably, the second attachment means 22a is at least one chain link or ring, the number of which create a length suitable for the second locking member 24 to reach the zipper of the bag, and to permit movement between the second locking member and the connecting member 14. As described above, the second locking member 24 can be any form of securing member, such as a hook or snap clasp, but is preferably a spring-loaded fasteners, such as a lobster claw clasp.

As shown in FIG. 6, the second locking member 24 adds to the theft deterrent feature of the present invention because it secures the zipper on the bag in either the closed position, or it prevents the zipper from being fully opened permitting access to the contents of the bag. When the second locking member 24 is engaged with the zipper tag, it would be difficult to open the zipper of a bag without the owner's knowledge. Use of the second locking member 24 deters pick pocketing of items from the interior of the bag. In addition, decorative elements, such as charms or jeweled rings 22b can be added, either permanently or removably to the attachment means 22a, adding a further decorative feature to the device 10.

As shown in FIG. 7, yet another embodiment of the present invention is directed to a zipper lock 28. The zipper lock 28 includes a biased closure connector 30 of the type described above. Attached to the connector 30 is an attachment means 32, including a chain, wire, strap, cord or cable, as described above. Preferably, the attachment means 32 is a plurality of chain links or metal rings. Secured on the opposing end of the chain links is a securing member 34, such as a toggle, hook or clasp. In use, the connector 30 would receive the strap of the bag, purse, backpack, etc., and the securing member 34 would be attached to the zipper tag at the end of the zipper on the bag. The zipper lock 28 prevents the zipper on the bag from being opened easily without the knowledge of the owner of the bag. As an alternative, decorative charms or jewels can be added to the attachment means 32, adding to the fashionable element of the device. Alternatively, keys, such as house or car keys or pass keys can be added to the connector 30 through the attachment means 32.

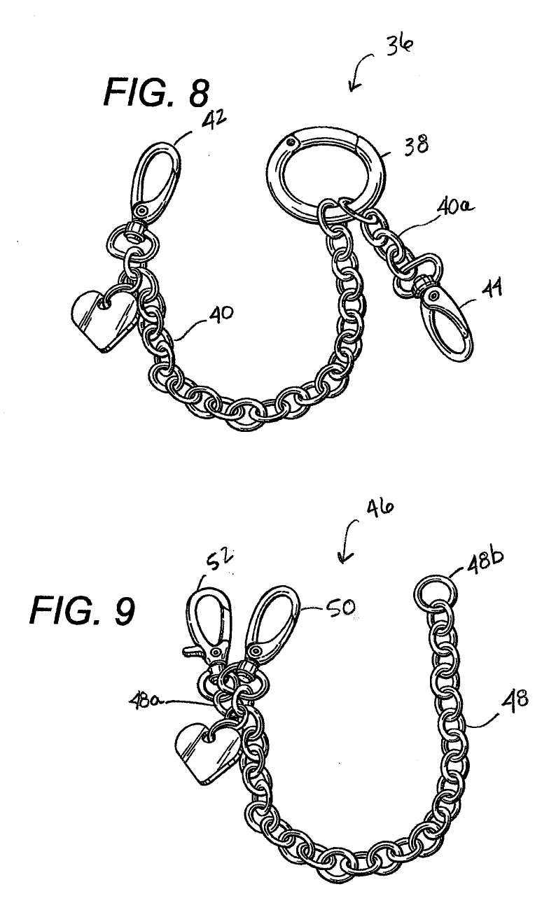

FIG. 8 shows another embodiment of the theft deterrent device 36 according to the present invention. The device 36 includes a biased closure connector 38 as previously described. Preferably, the connector 38 is a hinged ring, which can be biased between an open and a closed position for ease of attachment to the bag to be secured. The device 36 also includes at least one attachment means 40 connected to the connector 38 in a manner which permits movement of the attachment means around the circumference of the connector. The attachment means 40 can include a chain, wire, cord or cable made of a durable material, such as metal or plastic. Preferably, the attachment means 40 is a chain link or plurality of rings made of metal, including stainless steel, silver or gold plated metal, or precious metals, including sterling silver or 14K gold. Optionally, charms, ID tags, or other decorations can be added to the attachment means 40 to enhance the aesthetic design of the device.

The theft deterrent device 36 of FIG. 8 includes at least one locking member 42 attached to an end chain, link or ring of the at least one attachment means 40. When the device 36 is used to secure a potentially unsupervised bag the hinged ring 38 is first attached to the strap of the bag. The attachment means 40 is then wrapped around an object to which the bag is to be secured. The first locking member 42 then connects to the connector 38, securing the bag to the object. In a preferred embodiment, the device 36 includes a second attachment means 40a, secured to the connector 38 separate from the first attachment means 40. The second attachment means 40a is preferably the same construction as the first attachment means 40. A second locking member 44 is attached at an end chain, link or ring of the second attachment means 40a, opposed from the connector 38. The second locking member 44 is used to secure the closure device, such as a zipper, on the bag in a closed position, as previously described. The second locking member 44 also prevents the zipper on the bag from being opened easily without the knowledge of the owner of the bag. The locking members 42 and 44 can be any form of securing device including a toggle, hook, snap clasp or lobster claw clasp. Preferably, the locking members 42 and 44 are spring-loaded fasteners, such as a lobster claw clasp or snap clasp that remain closed until opened by the user.

FIG. 9 shows yet another embodiment of the device of the present invention. The device 46 includes an attachment means 48, having a first end 48a and a second end 48b, and at least one locking member 50. The attachment means 48 is as described in the earlier embodiments, and is preferably a chain link or series of rings. The locking member 50 is attached to the first end 48a of the attachment means 48, and can be any form of securing element including a toggle, hook, snap clasp or lobster claw clasp. When the device is in use as a theft deterrent, the attachment means 48 is wrapped around both a bag handle and the object to which the bag is secured. The first locking member 50 then engages the second end 48b of the attachment means 48, securing the bag and deterring theft. In a preferred embodiment, the device 46 includes a second locking member 52, positioned on the attachment means 48 proximate to first end 48a and the first locking member 50. The second locking member 52 is used to secure the closure device or zipper on the bag in a closed position and also prevents the zipper from being opened easily without the knowledge of the owner of the bag. Preferably, the locking members 50 and 52 are spring-loaded fasteners, such as a lobster claw clasp or snap clasp that remain closed until opened by the user.

Referring to FIGS. 1, 2, 6 and 8, to use the theft deterrent device of the present invention, the owner of the bag would attach the connector 14 to the strap of the bag by pushing the opening of the connector against the strap or metal hardware on the bag. In one embodiment, the user would pull on the locking member 16, releasing the cord 18 from the retracting member, to a desired length for attachment to the object to which the bag is to be secured. The cord 18 would then be wound around the portion of the object, such as an arm of a chair, and the locking member 16 would be attached to the connector 14. Using the embodiment of the theft deterrent device of FIG. 8, after attaching the connector 38 to the strap of the bag, the chain link attachment means 40 would be wound around the object to which the bag is to be secured, and the locking member 42 would engage the connector 38, as previously described. In this manner, the bag is secured to a stationary object or large, but movable object such as a grocery cart, discouraging easy removal of the bag or its contents. The second locking member 44 and 52 of the embodiments shown in FIGS. 8 and 9, respectively, would likewise secure the zipper of the bag in a closed position.

According to the embodiment of the invention shown in FIG. 6, the second locking member 24 is attached to the connector 14 through an attachment means 22, having a length suitable to reach the zipper of the bag. The user would attach the clasp 24 to the zipper tag at the end of the zipper. This second locking member 24 secures the zipper in the closed position, or prevents the zipper from being fully opened, deterring removal of items from the interior of the bag without the owner's knowledge. Upon removal of the bag from the chair, the locking member 16 is released from the connector 14 and the cord 18 is automatically rewound on the retracting member 20 inside the housing.

In yet another embodiment of the present invention, the device may be sewn into the lining of the purse or bag. Specifically, the housing 12 would be sewn into the lining, either interior or exterior lining of the handbag, backpack, briefcase, etc. The attachment means 22 and the first locking member 16, and optionally the second locking member 24 would protrude out from the lining, such that when the first locking member and cord 18 are pulled out from the housing, the housing remains secured within the lining. The device 10 would function in the same manner to secure the bag to a stationary object as previously described. Optionally, the second locking member 24 would also be used to secure the zipper on the bag, as previously discussed.

While the specific embodiments have been illustrated and described, numerous modifications come to mind without significantly departing from the spirit of the invention, and the scope of protection is only limited by the scope of the accompanying Claims.

1. A method for deterring theft of a bag, the method comprising the steps of:
a. providing a device comprising:
i. a connector;
ii. an attachment means attached to the connector; and,
iii. at least one locking member attached to the attachment means;
b. securing the connector to the bag;
c. wrapping the attachment means about an object to which the bag is to be secured; and,
d. connecting the locking member to the connector.

2. The method for deterring theft of a bag of claim 1, wherein the connector is a hinged ring biased to a closed position and moveable between an open and a closed position.

3. The method for deterring theft of a bag of claim 1, wherein the attachment means comprises a plurality of chain links or rings.

4. The method for deterring theft of a bag of claim 1, wherein the locking member is a spring-load fastener.

5. The method for deterring theft of a bag of claim 4, wherein the locking member is a clasp.

6. The method for deterring theft of a bag of claim 1, the method further including providing a second attachment means separately connected to the connector from the first attachment means.

7. The method for deterring theft of a bag of claim 6, the method further including providing a second locking member connected to the second attachment means and opposed to the connector.

8. The method for deterring theft of a bag of claim 7, the method further including the step of engaging the second locking member to a closure device on the bag.

9. A method for deterring theft of an unsupervised bag, the method comprising the steps of:
a. providing a device comprising:
i. an attachment means having a first end and a second end;
ii. a first locking member attached to the first end of the attachment means; and,
iii. a second locking member attached to the attachment means in close proximity to the first locking member;
b. wrapping the attachment means about an object to which the bag is to be secured; and,
c. connecting the first locking member to the second end of the attachment means; and,
d. connecting the second locking member to a closure device on the bag.

10. The method for deterring theft of an unsupervised bag of claim 9, wherein the attachment means is a plurality of chain links or rings.

11. The method for deterring theft of an unsupervised bag of claim 9, wherein the first locking member is a spring-loaded fastener.

12. The method for deterring theft of an unsupervised bag of claim 9, wherein the second locking member is a spring-loaded fastener.

13. A method for deterring theft of an unsupervised bag, the method comprising the steps of:
a. providing a device comprising:
i. a housing;
ii. a connector attached to one side of the housing, the connector capable of engaging the bag;
iii. at least one locking member attached to the housing through an attachment mean and opposing the connector;
iv. a cord having a first end connected to the locking member and a second end connected to a retracting member, the retracting member disposed within the housing;
b. releasing the cord and the locking member;
c. wrapping the cord around an object for securing the bag;
d. engaging the locking member with the connector;
e. securing the bag to the object to inhibit theft of the bag.

14. The method for deterring theft of a bag of claim 13, wherein the connector is a hinged ring biased to a closed position and moveable between an open and a closed position.

15. The method for deterring theft of a bag of claim 13, wherein the attachment means comprises a plurality of chain links or rings.

16. The method for deterring theft of a bag of claim 13, wherein the locking member is a spring-load fastener.

17. The method for deterring theft of a bag of claim 13, the method further including providing a second attachment means separately connected to the connector from the first attachment means.

18. The method for deterring theft of a bag of claim 17, the method further including providing a second locking member connected to the second attachment means and opposed to the connector.

19. The method for deterring theft of a bag of claim 13, the method further including the step of engaging the second locking member to a closure device on the bag.

20. A bag comprising:
an exterior and an interior:
a zipper on the exterior of the bag for opening and closing the bag; and,
a theft deterrent device removably attached to the exterior of the bag, the theft deterrent device comprising:
i. a connector:
ii. at least a first attachment means attached to the connector: and,
iii. at least a first locking member attached to the attachment means.

21. The bag of claim 20, wherein the connector is a hinged ring biased to a closed position and moveable between an open and a closed position.

22. The bag of claim 20, wherein the attachment means is a plurality of chain links or rings.

23. The bag of claim 20, wherein the locking member is a spring-loaded fastener.

24. The bag of claim 20, wherein the device further includes a second attachment means attached to the connector separate from the first attachment means.

25. The bag of claim 20, wherein the device further includes a second locking member connected to the second attachment means, the second locking member used for securing a zipper on the bag in a closed position.

26. The bag of claim 20, wherein the second locking member is a clasp.

27. A theft deterrent device comprising:
a connector removably attached to a bag;
a first attachment means attached to the connector;
a first locking member attached to the attachment means;
a second attachment means attached to the connector separate from the first attachment means: and,
a second locking member attached to the second attachment means, wherein the first attachment means wraps about an object to secure the bag, the first locking member engages the connector and the second locking member engage; a closure device on the bag.

27. The theft deterrent device of claim 26, wherein the connector is a hinged ring biased to a closed position and moveable between an open and a closed position.

28. The theft deterrent device of claim 26, wherein the attachment means comprises a plurality of chain links or rings.

28. The theft deterrent device of claim 26, wherein the locking member is a spring-loaded fastener.
